(19) United States
(12) Patent Application Publication
(10) Pub. No.: US 2004/0133525 A1
(43) Pub. Date: Jul. 8, 2004

(54) Wireless printing service

(76) Inventors: Harpreet Singh, Orange, CA (US); Louis Ormond, Irvine, CA (US)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 10/335,802

(22) Filed: Jan. 2, 2003

(51) Int. Cl. G06F 17/60

(52) U.S. Cl. 705/77

(57) ABSTRACT

A multifunction peripheral equipped with a communications system to communicate with wireless devices to initiate print jobs for printing and charge users for wirelessly printing documents. The system comprising a multifunction peripheral with a wireless communication server and a central server. A user of a wireless device, such as a laptop or PDA, approaches the multifunction peripheral and wirelessly connects to the peripheral. The system offers a web based user interface for the wirelessly connected user device to setup a print job and select a payment method. The system them calculates a cost and obtains user approval. The document is then printed, a central server then archives all transaction details and records for later retrieval.

### BACKGROUND OF THE INVENTION

The present invention is generally related to image output devices, and more particularly to an image output device receives document data from a wireless device.

Multifunction peripheral (MFP) devices are equipped with communications systems to communicate on 802.11, Bluetooth, and WiFi wireless networks. These devices allow users using wireless computing devices such as notebook computers or personal digital assistants (PDAs) to connect wirelessly to the peripheral and initiate a print job or other image output function. However, these devices do not provide a method for charging users for their print jobs, nor do they provide a method for the user to view charges for the print job in advance and approve the charge before the job is printing.

Furthermore, these MFP devices are often standalone devices. While this may be suitable for obtaining payment by credit card, wherein the transaction is either approved or not approved by the credit card provider, this is not suitable for options wherein a user may be using a prepaid account, coupon or partner account. A centralized server provides greater flexibility for these types of financial transactions. Furthermore, by using a centralized server, the user is not limited to a single MFP device, but may use any MFP device serviced by the centralized server.

Thus there is a need for a multifunction peripheral accessible by a wireless device to be able to provide a wide variety of payment options.

### BRIEF SUMMARY OF THE INVENTION

In view of the aforementioned needs, the invention contemplates a multifunction peripheral equipped with a wireless communications system with authentication means communicatively coupled to the wireless communication system adapted to authenticate the wireless device, and a payment processing system coupled to the image processing apparatus suitably adapted to process financial transactions associated with the production of the image. The system offers a web browser based user interface for a wirelessly connected user to setup a print job and select a payment method. A server communicatively coupled to the archives all transaction details and records for later retrieval and billing purposes.

Another aspect of the present invention is a method for an image apparatus to produce an image, the steps comprising receiving specifications of a document from a remote device, calculating a cost of producing an image of the document, obtaining user approval, and producing the image. Yet another aspect of the present invention is a computer-readable medium of instructions for carrying out the method of the present invention.

The present invention may be implemented in software, hardware, or a combination thereof.

Still other objects of the present invention will become readily apparent to those skilled in this art from the following description wherein there is shown and described a preferred embodiment of this invention, simply by way of illustration of one of the best modes best suited for to carry out the invention. As it will be realized, the invention is capable of other different embodiments and its several details are capable of modifications in various obvious aspects all without from the invention. Accordingly, the drawing and descriptions will be regarded as illustrative in nature and not as restrictive.

### BRIEF DESCRIPTION OF THE SEVERAL VIEWS OF THE DRAWING

The accompanying drawings incorporated in and forming a part of the specification, illustrates several aspects of the present invention, and together with the description serve to explain the principles of the invention. In the drawings:

FIG. 1 is a block diagram illustrating a system for a multifunction peripheral to receive print jobs from wirelessly connected users and charge the users for the wirelessly printed documents; and

FIG. 2 is a block diagram of a method contemplated by a preferred embodiment of the present invention; and

FIG. 3 is a block diagram illustrating the various interconnections between components.

### DETAILED DESCRIPTION OF INVENTION

Throughout this description, the preferred embodiment and examples shown should be considered as exemplars, rather than limitations, of the present invention.

The present invention is a system that offers to the provider of an 802.11, BlueTooth, or WiFi equipped multifunction peripheral (MFP) and print devices the ability to charge users for the wireless printing of print jobs. The system comprises an MFP with wireless communication capability, a means to communicate with an authentication server to authenticate wireless devices, and a payment system. The payment system would typically be a system to communicate with a remote server to obtain approval of a payment option selected by a user of the wireless device and the server would store all transaction details and records for future retrieval and billing purposes.

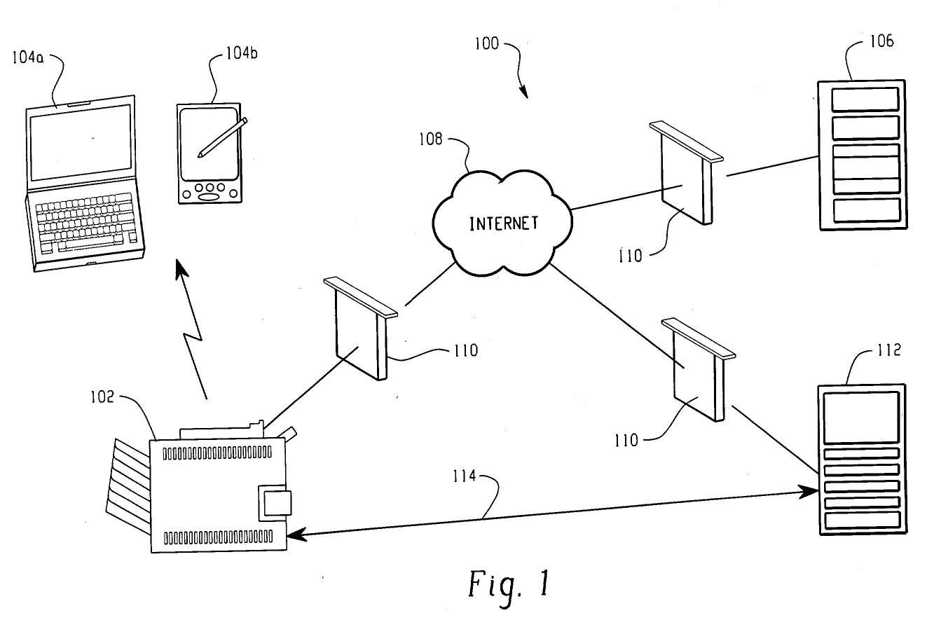

Referring now to FIG. 1, there is illustrated a system 100 exemplifying the present invention. The system comprises a MFP 102, an authentication server 106 and a central server 112. Wireless devices, such as notebook computer 104a and personal digital assistant 104b, connect to the MFP 102 using either the Bluetooth™ standard (Bluetooth), 802.11g (WiFi), or other 802.11 compliant device such as 802.11a or 802.11b. The wireless communication system within the MFP 102 authenticates the wireless devices 104a, 104b by communicating with an Authentication, Authorization and Accounting server (AAA server) 106 such as a Remote Authentication Dial-In User Service server (RADIUS server). As shown in FIG. 1, the MFP 102 is connected to the AAA server 106 via the Internet 108, however, the AAA server 106 may be connected to the MFP 102 by any data communications method. The central server 112 archives all the transaction details and records for later retrieval and billing purposes. As shown in FIG. 1, the central server 112 may be reached either by the Internet 108, or by a direct connection 114. The type of connection between the central server 112 and MFP 102 is not critical, any suitable type of data communication method would be acceptable. It would be preferable that the connection be secure to prevent fraud or unauthorized access to the central server 112. As shown in FIG. 1, firewalls 110 are between the MFP 102, AAA server 106, and central server 112, and the Internet 108.

As shown in FIG. 1, the AAA server 106 and central server 112 are separate entities, which is the preferred embodiment.. However, as those skilled in the art can readily appreciate there are other equivalent combinations suitable for use with the present invention. For example, a single server may comprise both the AAA server 106 and the central server 112 and could authenticate the wireless device and handle billing transactions. As another example, the AAA server 106 and central server 112 may be subsystems of the MFP 102.

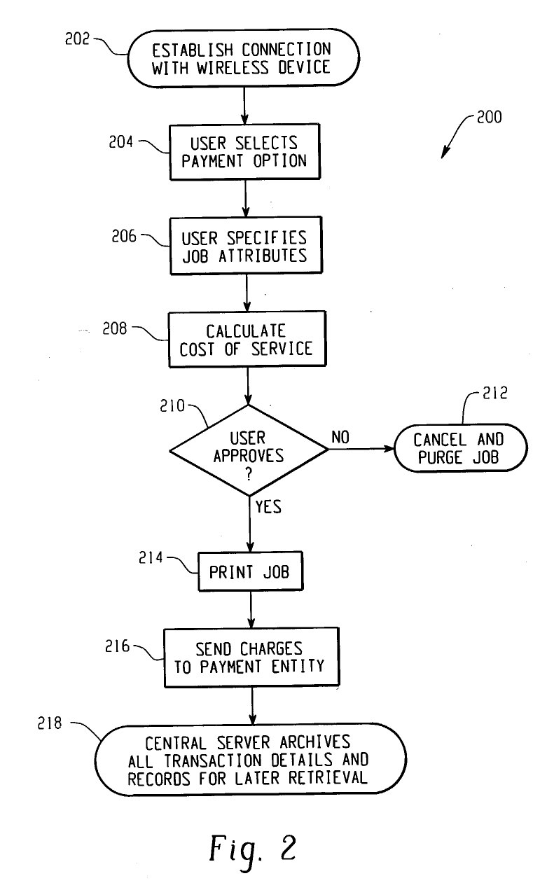

Referring now to FIG. 2, there is illustrated a method 200 of the present invention. The process begins at step 202 when a wireless device 104a or 104b connects with the MFP 102. The MFP 102 sends data to the wireless device 104a or 104b about available services offered by the MFP 102. The wireless device 104a or 104b then opens a web browser, or a device specific user interface, and presents the user with a description of the print services available and available payment options that are relevant for the user's specific location.

At step 204 the user selects a payment option. The payment options include any suitable payment options known in the art for charging for mobile fee-based services. Suitable 1 payment options include, but are not limited to, credit cards, prepaid accounts, coupons, and partner accounts. These payment options can be suitably group accounts and individual accounts. The user then selects the desired payment option from the options provided. The requirements for paying the fees depend on the payment option selected. If the user selects the credit card option, the user is prompted to provide selected information about the user's credit card, such as credit card type, credit card number, the credit card holder's name, and the expiration date. The information is provided by the user by any suitable means known in the art. Examples of such input are by direct user input via a keyboard interface or the like, or by access to a pre-stored information on a memory device or an intelligent card. The information is then sent to the central server 112 via the communication link 114 or the Internet 108 for authentication and approval from the credit card company. Such information is provided by the central server 112 to the credit card company by any suitable method known in the art. The authentication of the information and the transaction approval is provided by any suitable method known in the art. Preferably, the user is informed of the status of the approval. Preferably, if the transaction is not approved, the user is requested to submit information for an alternative credit card, or select an alternative payment option. In one embodiment, the user's credit card is charged for every transaction at the time of the transaction. In another embodiment, the user's credit card is charged for the transactions on a monthly or other suitable periodic interval.

If the user selects the prepaid account option, the user is prompted to open a prepaid account by a suitable method known in the art. Preferably, the user is prompted to open the prepaid account via a web-enabled user interface at specified URL that is served by the central server 112. The user provides selected information about a credit card or other type of debit card to open the account. Upon authentication of the information and approval of the use of the credit card by any suitable means, the user is issued an account identification and associated password for the account. Information about the account is maintained in any suitable database or repository, preferably, on the central server 112. In one embodiment, the balance maintained in the user account is debited every time the user accesses services on the system. In another embodiment, the balance is debited every month or other suitable periodic interval. The user may replenish the account by any suitable means at any time.

If the user selects the coupon option, the user is prompted to provide selected information about the coupons, such as the coupon issuer and the coupon number. This information is sent to the central server 112 by any suitable means known in the art. The authentication of the information and the transaction approval is provided by any suitable method known in the art. Preferably, the user is informed of the status of the approval. Preferably, if the transaction is not approved, the user is requested to correct the information or provide alternative information. Preferably, the user is provided information about any applicable limits or restrictions on services associated with the use of the coupons, such as the number of pages printed.

If the user selects the partner account option, the user is prompted to selected a third party account provider from a list of available options by any suitable means. Examples of partner accounts, include, but are not limited to, Sprint PCS, AOL, Liberty Alliance, MS Passport, and AT&T. The user is prompted to provide selected information about the account, such as the account or user identification, and password. The information is provided to the central server by any suitable means known in the art. Such information is provided by the central server to the partner company by any suitable method known in the art. The authentication of the information and the transaction approval is provided by any suitable method known in the art. Preferably, the user is informed of the status of the approval. Preferably, if the transaction is not approved, the user is requested to correct the information or provide alternative information. In one embodiment, the user's account is charged for every transaction at the time of the transaction. In another embodiment, the user's account is charged for the transactions monthly or other suitable periodic interval.

After selecting the desired payment option, the user is prompted to provide selected information about the desired service to be performed. If the user desires generate or receive image data using the multifunctional peripheral device and then stores or archives such image data in an associated repository, the user is prompted to provide information related to the repository. For example, the user is requested to provide the name or URL of the repository, the user identification, password, and duration that the information is to be stored in the repository. If the user desires to generate or receive image data using the multifunctional peripheral device, perform optical character recognition on the image data, and transmit the image data to at least one selected destination, the user is prompted to provide information about the parameters for performing the optical character recognition and about the at least one destination. If the user desires to generate or receive image data and then transmit the image data to at least one selected destination, the user is prompted to provide information about the at least one destination.

At step 206 the user then specifies the job attributes. These attributes would be dependent upon the type of transaction the user desires, whether it's a print job, fax, storage of a scanned document, or other image processing transaction. Thus at step 206, the user is then prompted to select the desired parameters for generating or receiving the image data. For example, if the user is scanning a document, the user suitably provides information about the type of scan, the rotation, the exposure, size, and related information.

After receiving such information, the system starts generating or receiving the image data. Preferably, after generating or receiving the image data, the system provides the user with the total cost associated with the selected services as shown at step 208. It is understood however, that the total cost associated with the selected services may be provided to the user prior to generating or receiving the image data.

At step 210 the user either approves or rejects the print job. If the user has rejected the print job, the print job canceled is purged as shown in step 212 and further processing stops.

However, once the user has accepted the services by any suitable means known in the art, the services are performed. As shown in step 214 the job is then processed. Preferably, the system provides a report of the status of the services to the user. Preferably, the user can view the results and make any needed changes to the services if the results are not acceptable. Information relating to the services is stored an associated repository, preferably located on the central server.

At step 216, the user is then billed for the services performed depending on the payment option selected by any suitable means known in the art. Preferably, a receipt is provided to the user upon completion of the services desired. At step 218 the central server 112 archives all transaction details and records for later retrieval, at which point the job is completed.

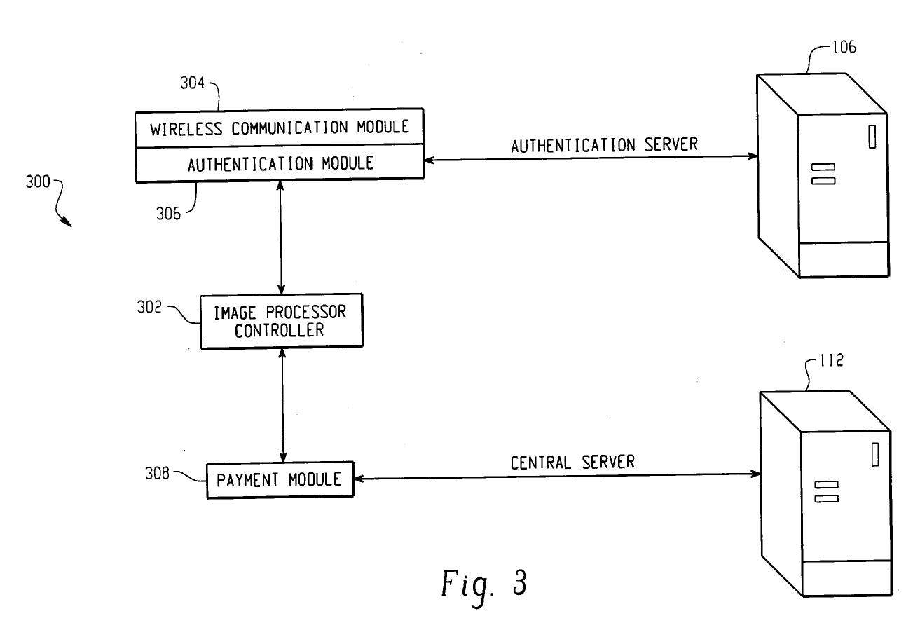

Referring now to FIG. 3, there is illustrated a block diagram 300 showing the interconnection between the various components. As shown in this embodiment, the MFP 102 has an image processor controller 302 for controlling the image processing operations of the MFP 102. When a wireless device (not shown) desires to communicate with the MFP 102, the wireless signal is received by the wireless communication module 304. The authentication module 306 determines whether the wireless device is authorized to communicate with the MFP 102. When the wireless device first communicates with the wireless communications module 304, the authentication module 306 authenticates the wireless device using the authentication server 106. Once the wireless device is authenticated, in a preferred embodiment session keys are generated and communicated by the wireless communication module 304 and the wireless device so that subsequent wireless traffic can be authenticated by the authentication module 306 without additional traffic to the authentication server 106, and then passed to the image processor controller 302.

Once the wireless device is authenticated, the image processor controller 302 then requests the job parameters from the wireless device and the payment options. The image processor controller 302 then communicates the payment options to the payment module 308, which then verifies the payment options with the central server 112. Once the payment options are confirmed by the central server 112, the image processor controller 302 processes the job.

The foregoing description of preferred embodiments of the invention have been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of the ordinary skill in the art to utilize the invention in various embodiments and with various modifications as are suited to the particular use contemplated. All such modifications and variations are within the scope of the invention as determined by the appended claims when interpreted in accordance to the breadth to which they are fairly, legally and equitably entitled.

What is claimed is:

1. An image apparatus, comprising:
an image processing apparatus adapted to receive a document and produce an image based on the document;
a wireless communication system communicatively coupled to the image processing apparatus, the wireless communication system adapted to receive a document from a wireless device;
authentication means communicatively coupled to the wireless communication system adapted to authenticate the wireless device; and
a payment processing system coupled to the image processing apparatus suitably adapted to process financial transactions associated with the production of the image.

2. The image apparatus of claim 1 wherein the image processing apparatus is a multi-function peripheral.

3. The image apparatus of claim 1 wherein the image processing apparatus is at least one of the group consisting of a facsimile device, a copier, and a printer.

4. The image apparatus of claim 1 wherein the wireless communication system is at least one of 802.11 compliant and Bluetooth complaint.

5. The image apparatus of claim 1, the authentication means comprises a network connection to an Authentication, Authorization and Accounting server.

6. The image apparatus of claim 5 wherein the Authentication, Authorization and Accounting server is a Remote Authentication Dial-In User Service server.

7. The image apparatus of claim 1 wherein the payment processing system comprises a connection to a credit card authorization means.

8. The image apparatus of claim 1 wherein the payment processing system comprises a connection to a prepaid accounts database.

9. The image apparatus of claim 1 wherein the payment processing system comprises means adapted to obtaining coupon information.

10. The image apparatus of claim 1 wherein the payment processing system comprises means for connecting to a partner account system over a network and to verify a partner account.

11. The image apparatus of claim 1 wherein the payment processing system comprises an archiving system adapted to archive all transaction details and records for producing the image.

12. The image apparatus of claim 1 further comprising a calculating system adapted to calculate a cost to produce the image.

13. The image apparatus of claim 12, the calculating system further comprising means adapted to obtain approval of the cost to produce the image.

14. A method for an image apparatus to produce an image, the steps comprising:
receiving specifications of a document from a remote device
calculating a cost of producing an image of the document
obtaining approval from the remote device; and
producing the image.

15. The method of claim 14 further comprising sending user approved charges to a payment entity.

16. The method of claim 14 further comprising archiving all transaction details and records.

17. The method of claim 14 further comprising presenting the remote device with a web browser interface adapted to obtain document production parameters.

18. The method of claim 14 wherein the remote device communicates with the image apparatus over a network.

19. The method of claim 14 wherein the remote device is a wireless device that communicates with the image apparatus via wireless communication.

20. The method of claim 14 further comprising authenticating the wireless device.

21. The method of claim 19 wherein the wireless device is authenticated by an Authentication, Authorization and Accounting server communicatively coupled to the image apparatus by a network.

22. A computer-readable medium of instructions, comprising:
means adapted to receive specifications of a document from a remote device
means adapted to calculate a cost of producing an image of the document
means adapted to obtain approval of the cost; and
means adapted to produce the image.

23. The computer-readable medium of instructions of claim 22 further comprising means adapted to send user approved charges to a payment entity.

24. The computer-readable medium of instructions of claim 22 further comprising means adapted to archive all transaction details and records.

25. The computer-readable medium of instructions of claim 22 further comprising means adapted to present the remote device with a web browser interface adapted to obtain document production parameters.

26. The computer-readable medium of instructions of claim 22 wherein the remote device communicates with the image apparatus over a network.

27. The computer-readable medium of instructions of claim 22 wherein the remote device is a wireless device that communicates with the image apparatus via wireless communication.

28. The computer-readable medium of instructions of claim 22 further comprising means adapted for authenticating the wireless device.

29. The computer-readable medium of instructions of claim 28 wherein the wireless device is authenticated by an Authentication, Authorization and Accounting server communicatively coupled to the image apparatus by a network.
